(19) United States
(12) Patent Application Publication
(10) Pub. No.: US 2016/0288071 A1
(43) Pub. Date: Oct. 6, 2016

(54) SYSTEMS AND METHODS FOR REDUCING CORROSION IN A REACTOR SYSTEM USING ROTATIONAL FORCE

(71) Applicant: EMPIRE TECHNOLOGY DEVELOPMENT LLC, Wilmington, DE (US)

(72) Inventors: George Charles PEPPOU, Hornsby Heights, New South Wales (AU); Benjamin William MILLAR, Rosebery, New South Wales (AU); Cameron Graeme COOKE, Pymble, New South Wales (AU)

(73) Assignee: EMPIRE TECHNOLOGY DEVELOPMENT LLC, Wilmington, DE (US)

(21) Appl. No.: 15/036,308

(22) PCT Filed: Nov. 12, 2013
(86) PCT No.: PCT/US13/69569

§ 371 Date: May 12, 2016

(51) Int. Cl. B01J 7/02; B01J 19/18; C23C 6/00; C10J 3/48; C10J 3/72; C10J 3/78; B01J 19/02; C01B 3/02

(52) U.S. Cl. CPC B01J 7/02; B01J 19/02; B01J 19/1806; C01B 3/02; C10J 3/487; C10J 3/72; C10J 3/78; C23C 6/00; B01J 2219/0236; B01J 2219/00245; C10J 2200/36

(57) ABSTRACT

Systems and methods for reducing or eliminating corrosion of components of a reactor system, including a supercritical water gasification system, are described. The reactor system may include various system components, such as one or more pre-heaters, heat exchangers and reactor vessels. The system components may be configured to receive a reactor fluid corrosive to an inner surface thereof and to separately receive a protective fluid that has a higher density and is substantially immiscible with the reactor fluid. A rotating element may be configured to generate a rotational force that forces at least a portion of the protective fluid to flow in a layer between the reactor fluid and at least a portion of the inner surface, the layer operating to reduce corrosion by forming a barrier between the reactor fluid and at least a portion of the inner surface.

### BACKGROUND

Reactor systems may generate fuel by reacting a fuel source with a reactor material under specific temperature and pressure conditions. For instance, a supercritical water gasification system may produce hydrogen-rich synthesis gas by reacting a feedstock slurry with supercritical water. Supercritical water is water that is heated to very high temperatures (for example, above about 400° C.) and under high pressures (for example, about 22 megapascals). Under these conditions, the water becomes very reactive and is capable of breaking down the slurry to generate the hydrogen-rich fuel. The fuel may be used for various purposes, such as powering an engine, producing electricity and generating heat.

One advantage of reactor systems is that they are capable of producing relatively clean hydrogen-based fuel from feedstocks that are considered waste, such as liquid biomass, or unclean fuel sources, including coal and other fossil fuels. One disadvantage is that system components are susceptible to corrosion and breaking down due to the harsh conditions that occur during the reaction process. As such, the efficiency and cost-effectiveness of reactor systems is dependent on the rate of corrosion of system components, such as heaters and reactor vessels that come into contact with reactor materials. Conventional techniques to manage corrosion involve the constant replacement of corroded parts, or constructing components from corrosive resistant materials, which can be expensive and largely ineffective. It will therefore be desirable to reduce corrosion in reactor systems in a manner that minimizes the economic impact of corrosion through inexpensive methods of protecting vulnerable portions of system components.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a reactor system configured to reduce corrosion of portions thereof may comprise a reactor vessel comprising an inner surface and a rotating element configured to rotate within the reactor vessel. The reactor vessel may be configured to receive a reactor fluid corrosive to at least a portion of the inner surface and a dense fluid having a higher density than the reactor fluid, the reactor fluid and the dense fluid being substantially immiscible. Rotation of the rotating element may generate a rotational force that forces at least a portion of the reactor fluid entering the reactor vessel to flow in a reactor fluid vortical flow within the reactor vessel, and at least a portion of the dense fluid entering the reactor vessel to flow in a dense fluid vortical flow that surrounds at least a portion of the reactor fluid vortical flow. The dense fluid vortical flow may operate to reduce corrosion by forming a barrier between the reactor fluid and the at least a portion of the inner surface.

In an embodiment, a method of reducing corrosion in a reactor system may comprise providing a reactor vessel comprising an inner surface and providing a rotating element configured to rotate within the reactor vessel. The reactor vessel may be configured to receive a reactor fluid corrosive to at least a portion of the inner surface and to receive a dense fluid having a higher density than the reactor fluid and substantially immiscible with the reactor fluid. The rotating element may be rotated to generate a rotational force that causes at least a portion of the reactor fluid to flow in a reactor fluid vortical flow as it flows through the reactor vessel and at least a portion of the dense fluid to flow in a dense fluid vortical flow that surrounds at least a portion of the reactor fluid vortical flow as it flows through the reactor vessel. The dense fluid vortical flow may operate to reduce corrosion by forming a barrier between the reactor fluid and the at least a portion of the inner surface.

In an embodiment, a method of manufacturing a reactor system configured to reduce corrosion of portions thereof may comprise providing a reactor vessel comprising an inner surface and configuring the reactor vessel to house a reactor fluid corrosive to at least a portion of the inner surface and a dense fluid having a higher density than the reactor fluid and substantially immiscible with the reactor fluid. A rotating element may be provided that is configured to rotate within the reactor vessel. Rotation of the rotating element may generate a rotational force that forces at least a portion of the reactor fluid to flow in a reactor fluid vortical flow within the reactor vessel and at least a portion of the dense fluid to flow in a dense fluid vortical flow that surrounds at least a portion of the reactor fluid vortical flow. The dense fluid vortical flow may operate to reduce corrosion by forming a barrier between the reactor fluid and the at least a portion of the inner surface.

In an embodiment, a reactor system configured to reduce corrosion of portions thereof may comprise a reactor vessel comprising an inner surface and a reactor vessel rotator configured to rotate the reactor vessel. The reactor vessel may be configured to receive a reactor fluid corrosive to at least a portion of the inner surface and a molten salt fluid. The reactor fluid and the molten salt fluid may be substantially immiscible with respect to each other. The reactor vessel rotator may be configured to rotate the reactor vessel at a speed such that at least a portion of the molten salt fluid forms a molten salt layer on the at least a portion of the inner surface. The molten salt layer operating to reduce corrosion by forming a barrier between the reactor fluid and the at least a portion of the inner surface.

In an embodiment, a method of reducing corrosion in a reactor system may comprise providing a reactor vessel comprising an inner surface and configuring the reactor vessel to receive a reactor fluid corrosive to at least a portion of the inner surface and to receive a molten salt fluid that is substantially immiscible with the reactor fluid. The reactor vessel may be rotated at a speed such that at least a portion of the molten salt fluid forms a molten salt layer on the at least a portion of the inner surface. The molten salt layer operating to reduce corrosion by forming a barrier between the reactor fluid and the at least a portion of the inner surface.

In an embodiment, a method of manufacturing a reactor system may comprise providing a reactor vessel comprising an inner surface and configuring the reactor vessel to receive a reactor fluid corrosive to at least a portion of the inner surface and a molten salt fluid that is substantially immiscible with the reactor fluid. At least one reactor vessel rotator may be connected to the reactor vessel that is configured to rotate the reactor vessel at a speed such that at least a portion of the molten salt fluid forms a molten salt layer on the at least a portion of the inner surface. The molten salt layer operating to reduce corrosion by forming a barrier between the reactor fluid and the at least a portion of the inner surface.

In an embodiment, a reactor system configured to reduce corrosion of portions thereof may comprise a reactor vessel comprising an inner surface and configured to receive a reactor fluid corrosive to at least a portion of the inner surface and a protective fluid substantially immiscible with the reactor fluid. A rotating element may be configured to generate a rotational force that forces at least a portion of the protective fluid to flow in a layer between the reactor fluid and the at least a portion of the inner surface. The layer operating to reduce corrosion by forming a barrier between the reactor fluid and the at least a portion of the inner surface.

### BRIEF DESCRIPTION OF THE DRAWINGS

FIG. 1 depicts an illustrative reactor system according to some embodiments.

FIGS. 2A and 2B depict a front view and a top-down view, respectively, of a system component configured according to some embodiments.

FIG. 3 depicts an illustrative system component according to a first embodiment.

FIG. 4 depicts an illustrative system component according to a second embodiment.

FIG. 5A depicts a first overview of an illustrative reactor system according to some embodiments.

FIG. 5B depicts a second overview of an illustrative reactor system according to some embodiments.

FIG. 6 depicts a flow diagram for an illustrative corrosion reduction method for a reactor system according to some embodiments.

FIG. 7 depicts a flow diagram for an illustrative corrosion reduction method for a reactor system according to a first embodiment.

FIG. 8 depicts a flow diagram for an illustrative corrosion reduction method for a reactor system according to a second embodiment.

### DETAILED DESCRIPTION

The terminology used in the description is for the purpose of describing the particular versions or embodiments only, and is not intended to limit the scope.

The described technology generally relates to systems and methods for reducing or eliminating corrosion in reactor systems. The reactor systems may include supercritical water reactor systems, such as a supercritical water gasification system. In particular, embodiments provide systems and methods for generating barriers between corrosive fluids and the surfaces of reactor system components. For instance, some embodiments generate a corrosion protection layer configured to provide a physical barrier against subcritical fluid in a reactor system. Subcritical fluid includes fluid at subcritical conditions or at a high temperature that is below the temperature for supercritical fluid. For instance, subcritical water may include water at about 325° C. to about 375° C. at a pressure of about 22 megapascals.

Use of the described technology can result in a reduction or elimination of corrosion in reactor system components relative to operation of the same or similar reactor system components without the described methods and materials. The degree of corrosion can generally be reduced by any amount. For example, the degree of corrosion can be reduced by at least about 10%, at least about 20%, at least about 30%, at least about 40%, at least about 50%, at least about 60%, at least about 70%, at least about 80%, at least about 90%, at least about 95%, at least about 96%, at least about 97%, at least about 98%, at least about 99%, and in an ideal situation, about 100% reduction (complete elimination of corrosion).

In an embodiment, a system component, such as a reactor vessel, may be configured to receive a reactor fluid corrosive to surfaces of the system component and a protective fluid that is substantially immiscible with the reactor fluid. A rotating element may be configured to generate a rotational force that forces the protective fluid to flow in a layer contiguous with an inner surface of the system component. The reactor fluid may flow through the system component within the layer formed by the protective fluid. As such, the layer formed by the protective fluid reduces corrosion of the system component by forming a barrier between the reactor fluid and the inner surface of the system component.

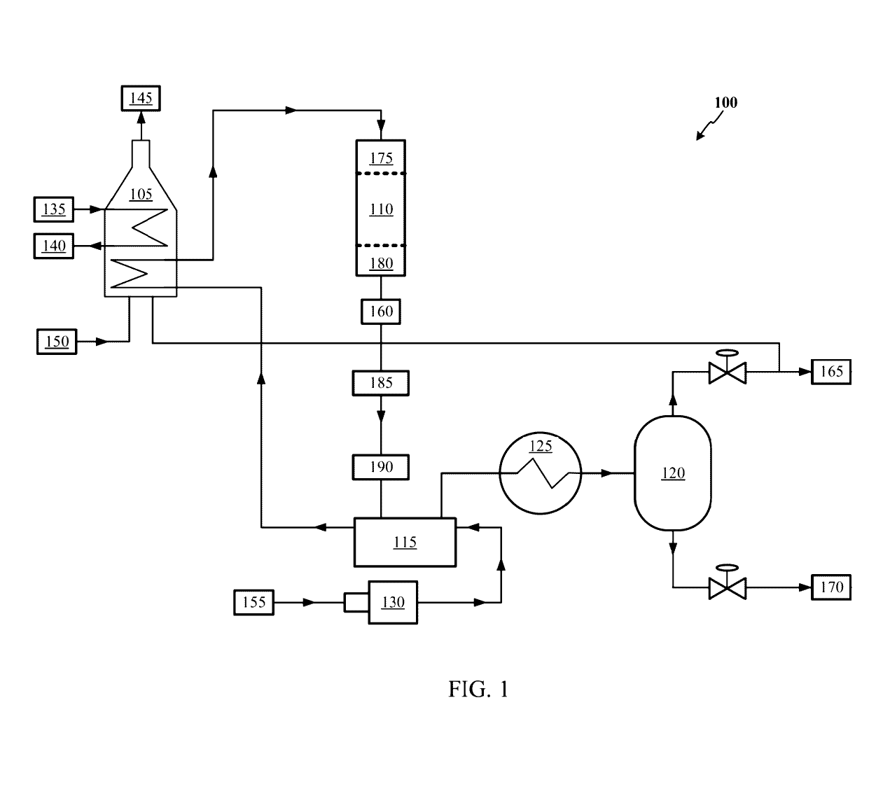

FIG. 1 depicts an illustrative supercritical water reactor system according to some embodiments. As shown in FIG. 1, a supercritical water reactor system 100 may include a feedstock inlet 130 for introducing a slurry 155 into the system. The slurry 155, for example, may include a high pressure slurry feed. The slurry 155 may include any type of matter capable of undergoing supercritical water gasification, including, without limitation, biomass fluids (for example, micro algae fluids, bioresidues, biowastes, or the like), slurries of coal and other fossil fuels (for example, pulverized coal and water), and oxidizable wastes. Accordingly, the supercritical water reactor system 100 may be configured to operate as any of various gasification systems, including, without limitation, a coal gasification system, a biomass gasification system, and a waste oxidation system. The slurry 155, along with air 150 and water 135, may be fed into a heater 105, or pre-heater, such as a gas-fired heater. The slurry 155 may be heated in the heater 105. Certain gases, such as steam 140 and flue gas 145, may be exhausted from the heater, for instance, to maintain pressure. The slurry 155 may be fed into a reactor vessel 110.

Within the reactor vessel 110, the slurry 155 may be heated under pressure to become a supercritical fluid. The temperatures and pressures for generating a supercritical fluid will depend on the type of slurry 155, any fluids included therein, and the composition thereof (for example, the type and concentration of ions at different temperatures and pressures). In an embodiment, the slurry 155 may be heated to above about 375° C. at a pressure above about 22 megapascals such that fluid within the slurry becomes a “supercritical fluid.” According to some embodiments, the slurry 155 may be heated to about 650° C. at a pressure of about 25 megapascals within the reactor vessel 110. The slurry 155 under supercritical conditions includes corrosive ions such as the ions of various inorganic salts. The corrosive ions may be highly corrosive to the components of the supercritical water reactor system 100, such as the inside surface of the heater 105, the reactor vessel 110, and/or any pipes connecting the components together. In an embodiment, the fluid within the slurry 155 may include water.

The supercritical fluid may react with the components of the slurry 155 within the reactor vessel 110 to generate a reactor product 160. In an embodiment, the slurry 155 may include one or more catalysts configured to facilitate the reaction, such as chlorine, sulfate, nitrate, and phosphate. The reactor product 160 may move through one or more heat exchangers, such as a heat recovery heat exchanger 115 and a cool-down heat exchanger 125. In an embodiment, a filter 185 may be positioned within the reactor system 100, such as between the reactor vessel 110 and the heat exchanger 115 to filter the reactor product 160. In an embodiment, a reservoir 190 including additional fluid and/or configured to provide additional pressure may be positioned within the reactor system 100. A gas/liquid separator 120 may be provided to separate the reactor product 160 into the desired fuel gas product 165 and waste products 170, such as liquid effluent, ash and char. The fuel gas product 165 may include any fuel capable of being generated from the slurry 155 responsive to reacting with the supercritical fluid. Illustrative fuel gas products 165 include, but are not limited to, hydrogen-rich fuels, such as H₂ and/or CH₄.

During the supercritical water gasification process, the slurry 155 may be heated to various temperatures under different pressures within the supercritical water reactor system 100. In addition to supercritical conditions, the slurry 155 may be in a subcritical condition, wherein the fluid within the slurry 155 is at an elevated temperature, under elevated pressure, that is below the supercritical temperature. In an embodiment wherein the fluid within the slurry 155 includes water, subcritical water may have a temperature of about 275° C., about 300° C., about 325° C., about 350° C., about 400° C., about 425° C., about 450° C. or in a range between any of these values (including endpoints). In an embodiment wherein the fluid within the slurry 155 includes water, the pressure of the fluid at the subcritical temperature may be about 20 megapascals, about 22 megapascals, about 25 megapascals, or in a range between any of these values (including endpoints). The slurry 155 under subcritical conditions typically includes corrosive ions that are highly corrosive to the components of the supercritical water reactor system 100. Non-limiting examples of corrosive ions include various ions of chlorine, sulfur (for example, sulfur dioxide), phosphorous, or the like.

The supercritical water reactor system 100 may have one or more subcritical zones where the slurry 155 is located during at least a portion of the supercritical water gasification process. Non-limiting examples of subcritical zones include, without limitation, the pre-heat 175 and cool-down 180 zones of the reactor vessel 110. According to some embodiments, the portion of the reactor vessel 110 between the pre-heat 175 and cool-down 180 zones may include supercritical water during the supercritical water gasification process. Although the pre-heat 175 and cool-down 180 zones are depicted in FIG. 1 as being within the reactor vessel 110, embodiments may provide for the pre-heat and cool-down zones to be located in different components, such as a pre-heater (for the pre-heat zone) and a heat exchanger (for a cool-down zone and/or both the pre-heat zone and the cool-down zone). In addition, the subcritical zones are not limited to the pre-heat 175 and cool-down 180 zones, as any portion of the supercritical water reactor system 100 where the slurry 155 is present in subcritical conditions may include a subcritical zone.

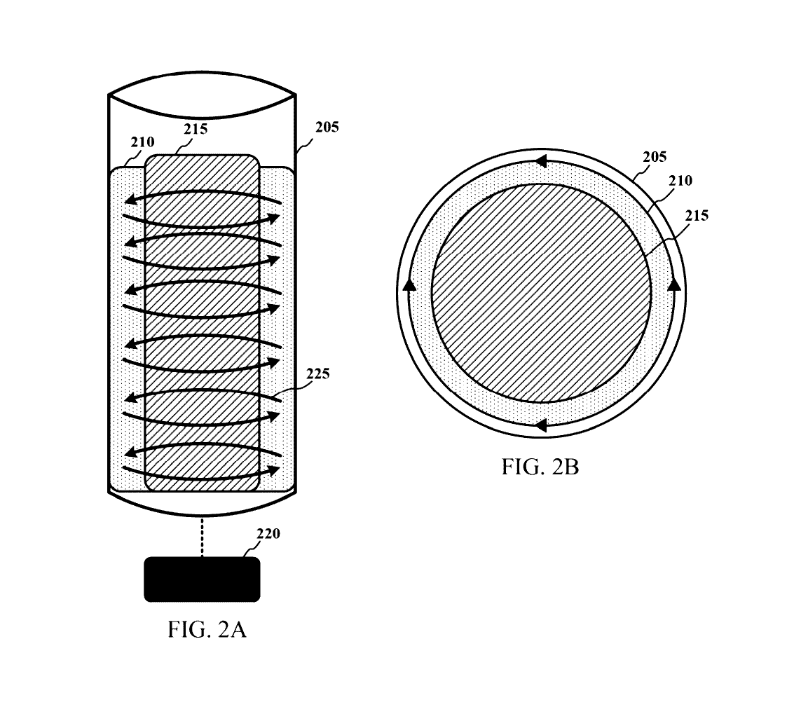

According to some embodiments, the slurry 155 may be more corrosive in subcritical conditions than in supercritical conditions. As such, embodiments provide for a fluid-formed protective layer (not shown in FIG. 1; see FIGS. 2A, 2B, 3 and 4 for more detail) configured to form a barrier between the subcritical water and the components of the supercritical water reactor system 100, for instance, within the subcritical zones.

The supercritical water reactor system 100 depicted in FIG. 1 is provided for illustrative purposes only and may include more or less components as required arranged in one or more configurations, sequences, connections, or the like, such as one or more valves, pre-heaters, reactor vessels, pumps for pumping the slurry 155 through the system and other components known to those having ordinary skill in the art.

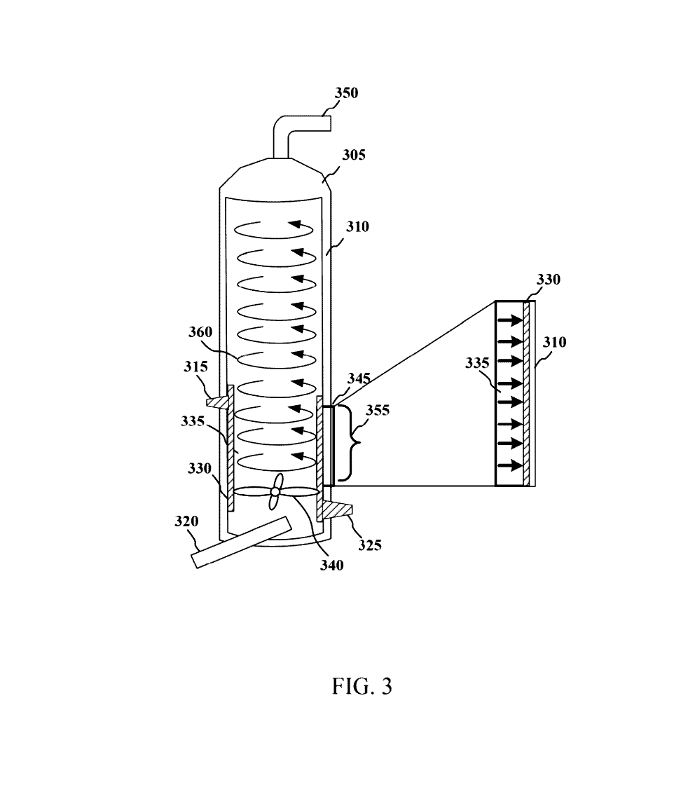

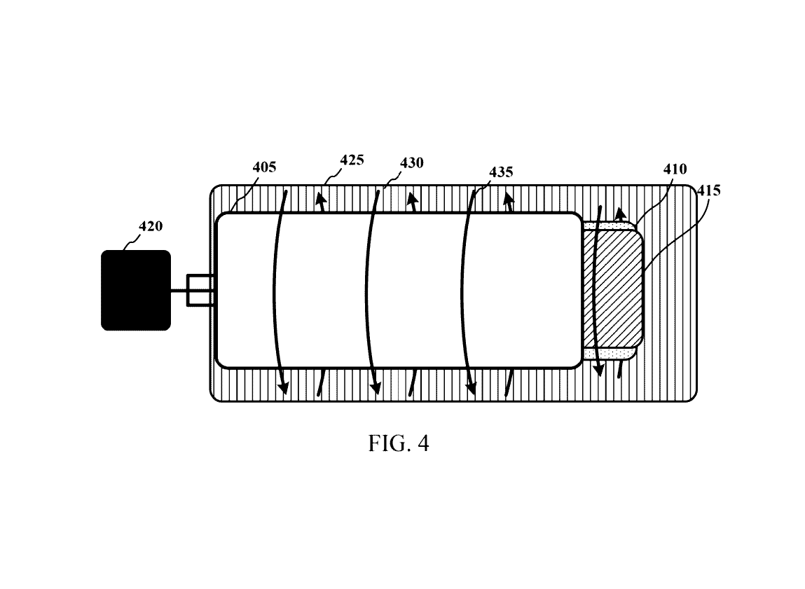

FIGS. 2A and 2B depict a front view and a top-down view, respectively, of a system component configured according to some embodiments. As shown in FIG. 2A, the system component 205 may be associated with a rotating element 220. The system component 205 may include any component or portions thereof requiring corrosion protection, such as a heater, pre-heater, heat exchanger, conduit piping, or the like. The rotating element 220 may be configured to rotate and generate a rotational force. In some embodiments, the rotating element 220 may include an impeller, rotor, or other rotating device configured to rotate in a manner that causes at least a portion of fluid within the system component 205 to flow in a vortical flow (see FIG. 3). In some embodiments, the rotating element 220 may include a rotor, motor, or the like coupled to the system component 205 and configured to cause the reactor vessel to rotate in a manner that causes fluid located therein to flow in a vortical flow (see FIG. 4). In general, a vortical flow is the flow of a fluid that includes a vortex of fluid rotating about an axis.

The system component 205 may be configured to receive a reactor fluid 215 that is corrosive to at least a portion of an inner surface of the reactor vessel. For example, the reactor fluid 215 may be corrosive due to corrosive ions contained therein. The system component 205 may also be configured to receive a protective fluid 210 that is not corrosive or is substantially less corrosive to the inner surface of the system component 205 as compared to the reactor fluid. In some embodiments, the protective fluid 210 may be substantially immiscible with the reactor fluid 215 such that the two fluids remain separated or substantially separated as each fluid flows through the system component 205. In some embodiments, the protective fluid 210 may be at least partially miscible with the reactor fluid 215. In such embodiments, a filter (for example, filter 185 of FIG. 1) may be provided that is configured to filter the protective fluid 210 and/or the reactor fluid 215 as necessary for operation of the reactor system process. For instance, the filter may be configured to remove elements of the protective fluid 210 from the reactor fluid 215 or vice versa after the reaction process has completed.

According to some embodiments, the protective fluid 210 may have a higher density than the reactor fluid 215. In such embodiments, the higher density protective fluid 210 may include a fluid configured at least partially from a metal, a metal alloy, a molten salt (for example, a salt in a liquid phase), a hydrocarbon liquid, or a combination thereof. Non-limiting examples of metals include tin, zinc, aluminum, lead, bismuth, lead-bismuth-eutectic (for example, about 44.5% lead by weight and about 55.5% bismuth by weight), gallium, cadmium, and an alloy of any combination thereof. Illustrative and non-restrictive examples of a molten salt include a molten salt of lithium fluoride and beryllium fluoride, a molten salt of lithium fluoride, sodium fluoride and potassium fluoride, a molten salt of sodium nitrate, sodium nitrite and potassium nitrate, a molten salt of potassium chloride and magnesium chloride, a molten salt of rubidium chloride and zirconium fluoride, or a molten salt of any combination thereof.

Molten salts are stable within reactor systems because of, among other things, the preferential bonding between the anion and the cation that form the salt. As such, reactivity between the reactor fluid 215 (for example, water) and a molten salt may be substantially limited. In addition, due to the thermal stability exhibited by molten salts, components of a reactor system configured according to some embodiments described herein may operate at a higher temperature and/or over a broader temperature range than a reactor system that does not use molten salts. During the reaction process, the reactor fluid 215 in a supercritical state has a finite soluble capacity. Accordingly, inorganic salts, such as those used as molten salts according to some embodiments, may be effectively insoluble under supercritical conditions and any salt in excess of the carrying capacity may precipitate. In some embodiments, at least a portion of the salts introduced into the reactor as part of a slurry may be carried from the system component 205 by the molten salt.

Operation of the rotating element 220 may generate a rotational flow or vortex within the reactor vessel, such as the vortex indicated by the flow lines 225. The vortex may operate to force the higher-density protective fluid 210 to be localized to the outermost portion of the reactor vessel. The lower-density reactor fluid 215 may flow within a centralized portion of the system component 205. As shown in FIG. 2B, the resulting flow configuration within the system component 205 from the outermost portion to the innermost portion includes the inner surface of the reactor vessel, the protective fluid 210 and the reactor fluid 215. In this manner, the protective fluid 210 forms a protective barrier between the reactor fluid 215 and the inner surface of the system component 205. The protective barrier reduces corrosion of the system component 205 by preventing corrosive elements of the reactor fluid 215 from contacting and, therefore, reacting with the inner surface of the reactor vessel.

The system component 205 may be formed from various materials, including, without limitation, Inconel® of the Special Metals Corporation, Hastelloy® N of Haynes International, Inc. (Huntington, W. Va. USA), titanium (Ti) and alloys thereof, stainless steel, a metal, a metal alloy, zirconium (Zr) alloys (for example, Zr-Tin (Sn), Zr-Niobium (Nb), and Zr—Sn—Nb), nickel (Ni) or alloys thereof (for example, Ni-Copper (Cu), Ni-Molybdenum (Mo), Ni-Iron (Fe)-Chromium (Cr)—Mo, or Ni—Cr—Mo), austenitic stainless steels, or combinations thereof.

FIG. 3 depicts an illustrative system component according to a first embodiment. As shown in FIG. 3, a system component 305 may be configured as a substantially cylindrical and vertically orientated reactor vessel, such as a continuous or batch reactor vessel. A reactor fluid 335 may enter the system component 305 through a reactor fluid inlet 320 arranged at a bottom portion of the system component. The reactor fluid 335 may include any type of fluid capable of operating according to embodiments described herein, such as a coal slurry, a biomass slurry, or other oxidizable fluid. The reactor fluid 335 may enter the reactor vessel 305 under high pressure, such as between about 20 megapascals to about 30 megapascals, and may flow from the bottom portion to a top portion of the system component and out through a reactor fluid outlet 350.

A protective fluid 330 may enter the system component 305 above the highly corrosive region 335 and may flow down toward the bottom portion of the system component, exiting through a protective fluid outlet 325. As such, some embodiments provide that the protective fluid 330 may flow through the system component in a direction opposite the flow of the reactor fluid 335. The protective fluid 330 may have a higher density than the reactor fluid 335 and may be immiscible or substantially immiscible with the reactor fluid. The density of the protective fluid 330 may be such that gravity may force the protective fluid to flow in a downward direction from the protective fluid inlet 315 to the protective fluid outlet 325. In an embodiment, the protective fluid 330 may include a molten metal and/or molten salt fluid as described herein.

In an embodiment, the protective fluid 330 may enter the system component 305 through a plurality of protective fluid inlets 335 and/or a narrow continuous inlet arranged around the circumference of the system component. In an embodiment, the protective fluid 330 exiting the protective fluid outlet 325 may be cleaned of impurities, for example, through the use of a filter, and reused within the reactor system. Impurities may operate to increase the corrosiveness of a fluid, such as the protective fluid 330 and/or the reactor fluid 335, for instance, by raising the oxidation potential of the fluid. As such, removing impurities may operate to lower the corrosiveness of fluids contained within the system component 305.

A rotating element in the form of an impeller 340 may be arranged within the system component 305. The impeller 340 may be positioned at a bottom portion of the system component 305, for example, below a highly corrosive region 355 thereof. For instance, the highly corrosive region 355 may include a region of the system component in which the reactor fluid 335 is at a temperature of about 300° C. to about 350° C. Such regions of the system component 305 may be the most susceptible to corrosion due to the high temperatures, ion concentration and pressures as well as the abrasive nature of slurries typically used in reactor processes. The impeller 340 may rotate and impart a rotational force on the fluids 330, 335 flowing within the system component 305 as indicated by flow lines 360.

The impeller 340 may be formed from various materials capable of operating according to some embodiments described herein, including, without limitation, brass, titanium, aluminum, alloys thereof, or combinations thereof. The impeller 340 may be driven by a drive mechanism (not shown) operatively coupled thereto, such as a magnetically coupled drive shaft. In an embodiment, a labyrinth seal may be used to seal across a continuous drive shaft as it passes through a wall of the system component 305 to prevent leakage of fluids from the drive shaft. The impeller 340 may be configured to rotate at various speeds, depending, for example, on the type of protective fluid 310 and/or the dimensions of the system component 305. For instance, the impeller 340 may rotate at about 20 revolutions per minute, about 30 revolutions per minute, 50 revolutions per minute, about 100 revolutions per minute, about 200 revolutions per minute, about 300 revolutions per minute, about 500 revolutions per minute, about 1000 revolutions per minute, about 1500 revolutions per minute, about 2000 revolutions per minute, about 3000 revolutions per minute, about 3500 revolutions per minute, and ranges and values between any two of these values (including endpoints).

In an embodiment, the reactor fluid inlet 320 may be positioned just below the impeller 340 and may be angled such that the flow of reactor fluid 335 entering the system component 305 is in the direction of the rotational force generated by the impeller. The reactor fluid 335 may enter the system component 305 at a temperature that is lower than the temperature within the highly corrosive region 355, such as less than about 200° C., being heated as it flows toward the top of the system component. In a similar manner, the protective fluid inlet 315 may be positioned such that the flow of the protective fluid 330 into the system component 305 promotes the vortical flow of the protective fluid.

The rotational force generated by the impeller 340 may operate to force the protective fluid 330 and the reactor fluid 335 to flow in a vortical flow through the system component 305. As shown by area of detail 345, the vortical flow may force the denser protective fluid 330 toward the outermost portion of the system component 305 such that the protective fluid flows in an area substantially contiguous with an inner surface of the system component. The lower-density reactor fluid 335 flows in an innermost portion of the system component 305, separated from the inner surface of the system component by the barrier formed by the vortical flow of the protective fluid 330. In an embodiment, the protective fluid 330 may be introduced into the system component 305 at a constant rate such that the inner surface of the system component is protected by a substantially constant surface coating of the protective fluid.

In an embodiment in which the system component 305 is configured as a heat exchanger, the inlets 315, 320, outlets 325, 350 and the impeller 340 may be positioned such that the flow of the protective fluid 330 and/or the reactor fluid 335 occurs in a direction opposite the direction of fluid flows described above. For instance, the reactor fluid 335 may enter through the reactor fluid inlet 320 positioned at a top of the system component 305. In such an embodiment, the reactor fluid 335 may enter the system component 305 at a temperature above 350° C. (for example, the highest temperature of the highly corrosive zone 355). As the reactor fluid 335 moves through the system component 305, it may cool to a temperature between about 300° C. to about 350° C. and may be incorporated into the vortex generated by the impeller 340 and collected at the bottom of the system component 305. In this manner, some embodiments may provide corrosion protection during both heating and cooling phases of the reactor system process. In some embodiments, such as embodiments in which the system component 305 is configured as a heat exchanger, the protective fluid 330 may operate as a heat transfer medium.

According to some embodiments, the protective fluid 330 may be selected such that the reactor fluid 335 will not solvate into portions of the protective fluid and the protective fluid will not solvate into portions of the reactor fluid. In an embodiment, the protective fluid 330 may include a liquefied or molten metal or alloy thereof. For instance, a metal or metal alloy may be selected as the protective fluid 330 because of the minimal solubility of the reactor fluid 335, such as a reactor fluid used in a supercritical water gasification process. In an embodiment, the protective fluid 330 may include a fluid configured at least partially from a metal, a metal alloy, a molten salt, a hydrocarbon liquid, or a combination thereof. Illustrative metals include, without limitation, tin, zinc, aluminum, lead, bismuth, gallium, cadmium, and an alloy of any combination thereof. According to some embodiments, any metals in the protective fluid 330 incorporated into the reactor fluid 335 may be removed, for example, during one or more filtering and/or phase separation processes.

In an embodiment, the protective fluid 330 may include a hydrocarbon, fossil fuel-derived waste, such as coal tar, liquid fluorinated polymers, black liquor (for example, lignin-rich waste from paper making processes), or the like. In such an embodiment, the protective fluid 330 may solvate with the supercritical water of the reactor fluid 335 during the reaction process. Such a hydrocarbon-based protective fluid 330 may provide improved phase separation properties in the pre-critical phase of a supercritical water gasification process and, due to the non-polar properties, solvation of corrosive species in the reactor fluid 335 may not occur.

In an embodiment, at least a portion of the inner surface of the system component 305 may be coated with one or more materials that provide protection for the inner surface of the system component from reacting with the protective fluid 330. For instance, at least a portion of the inner surface of the system component may be coated with a ceramic refractory lining, for example, if the protective fluid 330 includes a molten metal. In addition, the inner surface of the system component 305 may include various structures configured to improve flow characteristics, for example, by reducing turbulence to reduce wear of the inner surface of the system component. In an embodiment, the inner surface of the system component 305 may include riblets, such as sinusoidal riblets, incorporated therein.

According to some embodiments, the protective fluid 330 may be cycled continuously within the reactor system. Constant cycling facilitates, among other things, the protective fluid 330 to be used as a heat transfer medium. For example, the protective fluid 330 may flow through a heat exchanger before entering a heater/pre-heater to reduce heat loss by transferring heat directly from the cooling portions to the heating portions of the flow of fluid through the reactor system (such as the reactor system 100 of FIG. 1). In another example, the protective fluid 330 may be used as a heat conducting medium, heated to a high temperature during input into a system component 305 to increase the rate at which the reactor fluid 335 is heated. In this example, once the protective fluid 330 is removed from the system component 305, such as a heat exchanger, the protective fluid may be directed into a second system component, such as a heater/pre-heater, allowing waste heat to be immediately utilized to achieve a desired temperature of the reactor fluid 335.

Although the embodiment depicted in FIG. 3 illustrates forming a barrier of protective fluid 330 only in a highly corrosive region 355, embodiments are not so limited. Indeed, forming a barrier of protective fluid in other regions, such as substantially the entire inner region of a system component 335, is contemplated herein.

FIG. 4 depicts an illustrative system component according to a second embodiment. As shown in FIG. 4, a system component 405 may be configured to receive a protective fluid 410 and a reactor fluid 415. In an embodiment, the protective fluid 410 may have a higher density than the reactor fluid 415 and may be immiscible or substantially immiscible with the reactor fluid. In an embodiment, the protective fluid 415 may include a molten salt. The system component 405 may include any system component of a reactor system capable of operating according to some embodiments described herein, such as a reactor vessel, heater/pre-heater, or a heat exchanger. The reactor fluid 415 may include a fluid used in a reactor system, including a slurry, such as a coal or biomass slurry.

The system component 405 may be coupled to a rotating element 420 configured to impart a rotational force on the system component. The rotational force may operate to rotate the system component 405, as indicated by lines of rotation 435. The rotating element 420 may include any type of rotating device capable of rotating a system component 305 according to some embodiments. For instance, the rotating element 420 may include a motor, such as an electric or gas-powered motor, configured to rotate a shaft and/or gears connected to the system component 405. In another instance, the rotating element 420 may include turbine blades coupled to the system component 405 and configured to use high-pressure protective fluid 410 to rotate the system component. In an embodiment, at least a portion of the energy required to rotate the system component 405 through the rotating element 420 may be dispersed as heat to the system component, for example, to support endothermic reactions occurring therein.

Rotation of the system component 405 may generate a rotational force that causes the protective fluid 410 and the reactor fluid 415 to rotate in a vortical flow as each fluid flows through the system component. As the protective fluid 410 rotates in a vortical flow, the protective fluid is forced to the outermost portion of the system component 405, forming a layer of protective fluid contiguous with an inner surface of the system component. The reactor fluid 415 flows through the system component within the layer of protective fluid 410. As such, corrosion of the system component 405 is substantially reduced or eliminated as the layer of the protective fluid 410 prevents the corrosive reactor fluid 415 from contacting the inner surface of the system component. In an embodiment, the system component 405 may comprise internal ribbing on at least a portion of the inner surface to increase friction between the protective fluid 410 and the inner surface. The rotating element 420 may be configured to rotate the system component 405 at various speeds sufficient to force the protective fluid 410 to form a layer of protective fluid contiguous with an inner surface of the system component. For instance, the rotating element 420 may rotate the system component 405 at about 20 revolutions per minute, about 30 revolutions per minute, 50 revolutions per minute, about 100 revolutions per minute, about 200 revolutions per minute, about 300 revolutions per minute, about 500 revolutions per minute, about 1000 revolutions per minute, about 1500 revolutions per minute, about 2000 revolutions per minute, about 3000 revolutions per minute, about 3500 revolutions per minute, and ranges and values between any two of these values (including endpoints).

In an embodiment, the system component 405 may be orientated in a horizontal or substantially horizontal orientation. In such an embodiment, the rotation element 420 may be configured to rotate at a speed sufficient to generate a centripetal acceleration on at least a portion of the protective fluid 410 greater than that of the acceleration of gravity in order to cause the vortical flow of the protective fluid to generate a protective layer. For example, for a 200 liter drum having a radius of about 33 centimeters, the drum may need to be rotated at a rate of about 50 revolutions per minute. In this embodiment, the protective fluid 410 and/or the reactor fluid 415 may be pressurized to force the fluid through the system component 405. The aforementioned 200 liter drum is provided for illustrative purposes only as the dimensions of the system component 405 may depend on, among other things, the particular reaction properties (for example, the residence time of the reactor fluid 415 to complete the reaction) and/or other characteristics of the reactor system. In addition, the rotational speed of the system component 405 may be a product of the dimensions of the system component.

In an embodiment, the system component 405 may be orientated in a vertical or substantially vertical orientation. In such an embodiment, the protective fluid 410 may enter the system component 405 through an inlet (not shown) positioned above an outlet (not shown) for the protective fluid. The protective fluid 410 and/or the reactor fluid 415 may be pressurized and/or may rely on the force of gravity to move through the system component 405. The protective fluid 410 may flow in a vortical flow as it flows from the inlet to the outlet.

In an embodiment, the system component 405 may be arranged within a support structure 425 configured to support the system component and to facilitate rotation thereof. The support structure 425 may be formed from a metal alloy, such as a nickel alloy. A rotation support element 430 may be disposed between the support structure 425 and the system component 405 to further facilitate the rotation of the system component, for example, operating as a fluid bearing. According to some embodiments, the rotation support element 430 may include a rotation support fluid, such as a molten salt, and/or ceramic bearings.

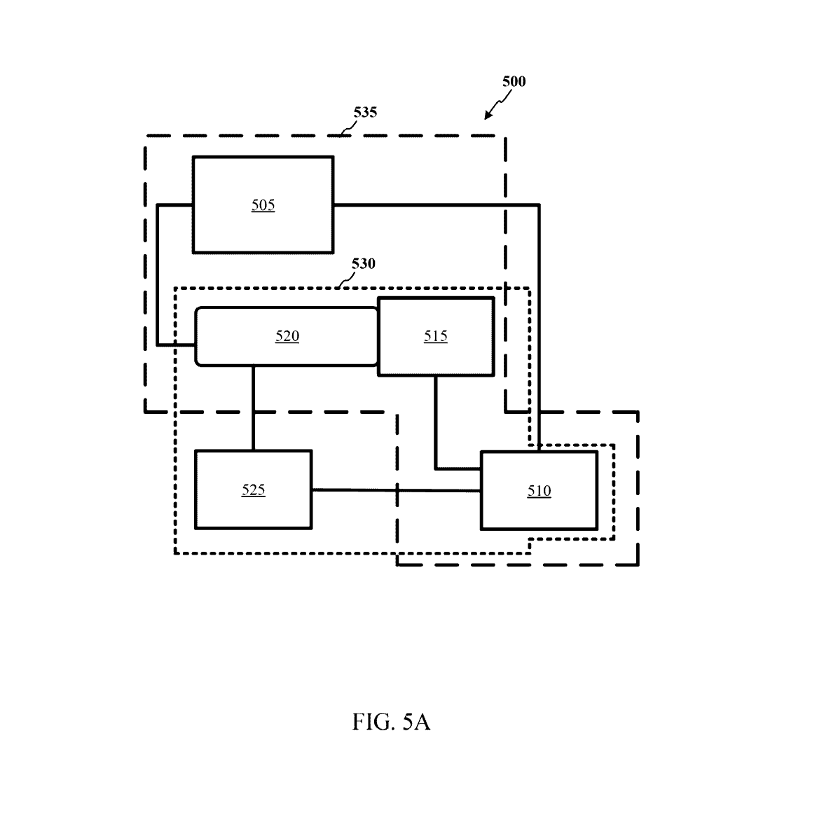

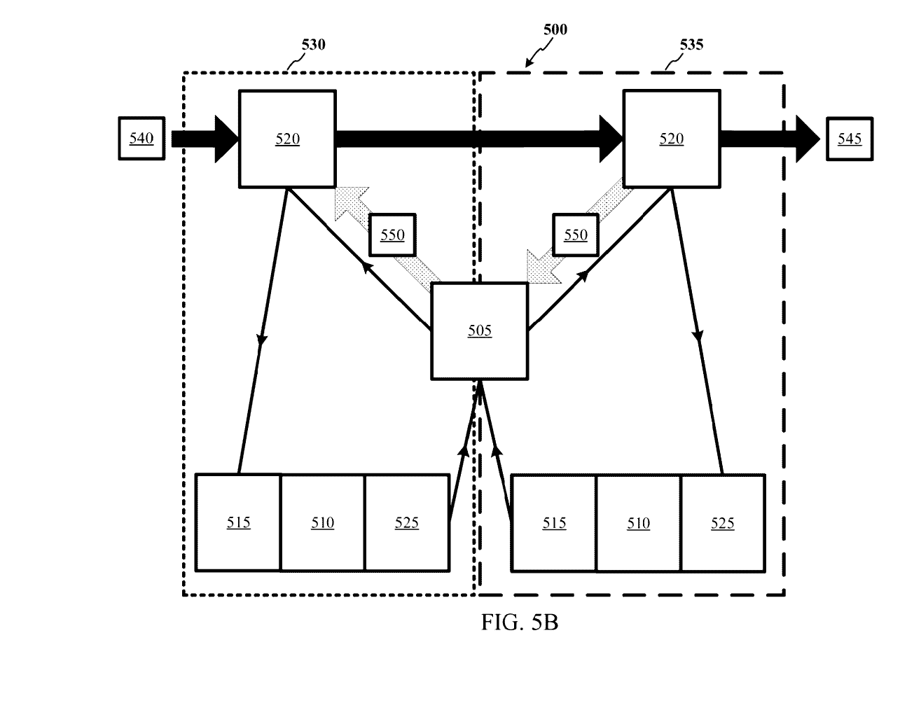

FIG. 5A depicts a first system overview of an illustrative reactor system according to some embodiments. As shown in FIG. 5A, a reactor system 500 may include system components arranged in one or more loops or flow circuits, such as a supercritical reaction loop 530 and a synthesis gas cooling loop 535. According to some embodiments, the reactor system 500 may be segmented into different loops 530, 535 in order to, among other things, increase the efficiency of the reactor system. The supercritical reaction loop 530 may be configured to facilitate the reaction of supercritical water with a source product fluid, such as a slurry of coal, biomass or the like to produce a gas product.

The supercritical reaction loop 530 may include a reactor vessel 520 configured to rotate in a manner similar or substantially similar to the system component 405 depicted in FIG. 4. The reactor 520 may be in fluid communication with a separator 515 configured to separate contaminants from the protective fluid. In an embodiment, the protective fluid may include a molten salt. For the higher temperatures employed in the supercritical reaction loop 530, a molten salt stable at higher temperatures may be used, such as a molten salt of lithium fluoride and beryllium fluoride or a molten salt of lithium fluoride, sodium fluoride and potassium fluoride. According to some embodiments, the eutectic composition (the composition with the lowest melting point) of a molten salt may be used.

The separator 515 may be configured to operate according to various separation processes, including, without limitation, filtration, distillation/evaporation/volatility separation, centrifugal separation, reductive extraction using metal transfer, and combinations thereof.

The separator may be in fluid communication with a cleaning vessel 510 that operates to further clean the protective fluid and/or the reactor fluid. For example, the cleaning vessel 510 may operate to electrochemically purify the protective fluid, such as a molten salt. In an embodiment, the contaminants removed from the protective fluid and/or the reactor fluid may be recovered, such as quartz, mullite, hematite, magnetite, lime, gypsum, silica, alumina, or the like. The cleaning component 510 may be in fluid communication with a heater 525 configured to heat the protective fluid and/or the reactor fluid before entering the reactor vessel 520. According to some embodiments, the protective fluid may flow through the supercritical reaction loop 530 in the order of the reactor vessel 520, the separator 515, the cleaning vessel 510, the heater 525, and back to the reactor vessel. In an embodiment, a pump (not shown) may be configured to force the protective fluid through the reactor system 500. The reactor fluid and/or any synthesis gas may flow from the reactor vessel 520 to a heat exchanger 505 of the synthesis gas cooling loop 535, for example, through the separator 515 or directly from the reactor vessel 520 to the heat exchanger 505.

In an embodiment, the protective fluid that flows through supercritical reaction loop 530 may be at a temperature sufficient to cause water coming into contact therewith to become supercritical. In this manner, water contamination of the salt may be prevented. In some embodiments, the protective fluid may be about 200° C. to about 650° C. In some embodiments, the protective fluid may be about 200° C. to about 250° C. In some embodiments, the protective fluid may be about 400° C. to about 600° C.

The synthesis gas cooling loop 535 may be configured to cool the reactor fluid and any synthesis gas product produced in the supercritical reaction loop 530. The synthesis gas cooling loop 535 may include a heat exchanger 505 in fluid communication with the supercritical reaction loop 530 and a reactor vessel 520. The reactor vessel 520b may be in fluid communication with a separator 515, which is in fluid communication with a cleaning vessel 510. The cleaning vessel 510 may be in fluid communication with the heat exchanger 505. In an embodiment, the protective fluid may flow through the synthesis gas cooling loop 535 in the following order: reactor vessel 520, separator 515, cleaning vessel 510, heat exchanger 505, and back to the reactor vessel. Due to the lower temperatures employed in the synthesis gas cooling loop 535, a molten salt stable at lower temperatures may be used, such as a molten salt of sodium nitrate, sodium nitrite and potassium nitrate (for example a 7%, 49%, 44%, respectively, molar solution; also referred to as Hitec salt).

According to some embodiments, the protective fluid flowing through the synthesis gas cooling loop 535 may operate to cool the synthesis gas and/or reactor fluid (for instance, water) entering the synthesis gas cooling loop from the supercritical reaction loop 530. For instance, the protective fluid entering the reactor vessel 520 may be at a temperature just above its respective melting point and may be removed once the protective fluid reaches equilibrium with the synthesis gas and/or reactor fluid. For instance, for a Hitec salt, the melting point may be about 142° C. In addition, the protective fluid may be used to preheat the reactor product (for instance, a slurry) entering the supercritical reaction loop 530 through the use of the heat exchanger 505.

FIG. 5B depicts a second system overview of an illustrative reactor system according to some embodiments. As shown in FIG. 5B, a slurry 540, such as a coal slurry, may enter the reactor system 500 at the reactor vessel 520 and may be discharged as syngas and water 545. As the slurry 540 is being processed within the reactor system 500, thermal energy 550 may be transferred between the heat exchanger 505 and the reactor vessel 520. For example, within the synthesis gas cooling loop 535, thermal energy 550 may be transferred from the reactor vessel 520 to the heat exchanger 505. Within the supercritical reaction loop 530, the thermal energy 550 may be used to heat up the reactor vessel 520 and the contents thereof. As shown in FIG. 5B, within the supercritical reaction loop 530, the thermal energy 550 may be transferred from the heat exchanger 505 to the reactor vessel 520.

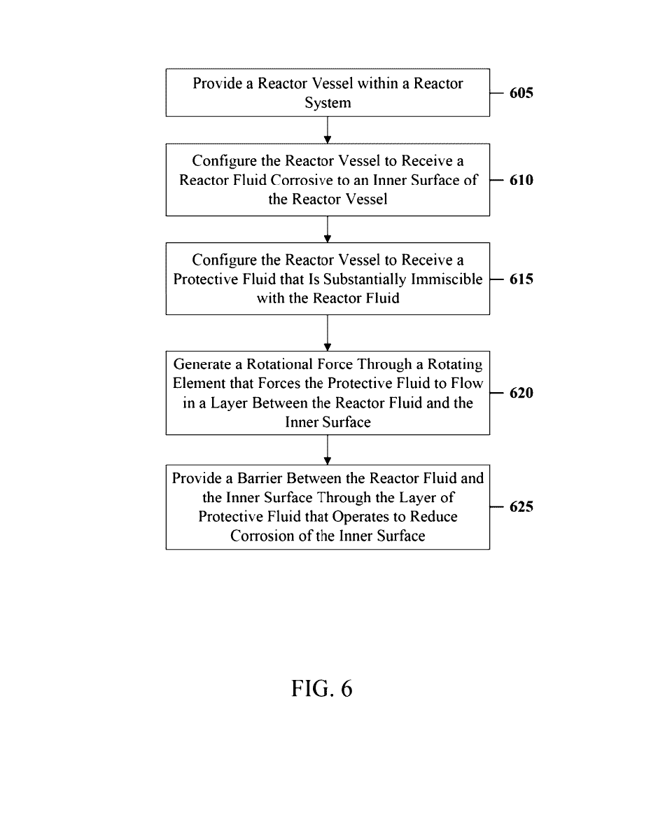

FIG. 6 depicts a flow diagram for an illustrative corrosion reduction method for a reactor system according to some embodiments. A system vessel may be provided 605 within a reactor system such as a supercritical water reactor system. An illustrative system vessel is the supercritical water reactor system 100 depicted in FIG. 1. The system vessel may include any reactor system component, such as that of a supercritical water reactor system, having a subcritical zone, for example, a region in contact with subcritical fluid during the supercritical water reactor process that is susceptible to corrosion by corrosive ions in the subcritical fluid. Non-limiting examples of components include reactor vessels, heaters, pre-heaters, heat exchangers, conduits, and piping.

The reactor vessel may be configured 610 to receive a reactor fluid, such as a slurry and/or water, which is corrosive to an inner surface of the reactor vessel. The reactor vessel may also be configured 615 to receive a protective fluid that is substantially immiscible with the reactor fluid. In an embodiment, the protective fluid may include a molten salt and/or a fluid containing a metal and/or metal alloy. In an embodiment, the protective fluid may have a higher density than the reactor fluid. A rotational force may be generated 620 through a rotating element that forces the protective fluid to flow in a layer between the reactor fluid and the inner surface. For example, the rotational force may cause the higher density protective fluid to flow in a vortical flow at the outermost portion of the interior of the reactor vessel. The reactor fluid may flow through the reactor vessel within the vortical flow of the protective fluid. As a result, a barrier may be provided 625 between the reactor fluid and the inner surface through the layer of protective fluid that operates to reduce corrosion of the inner surface.

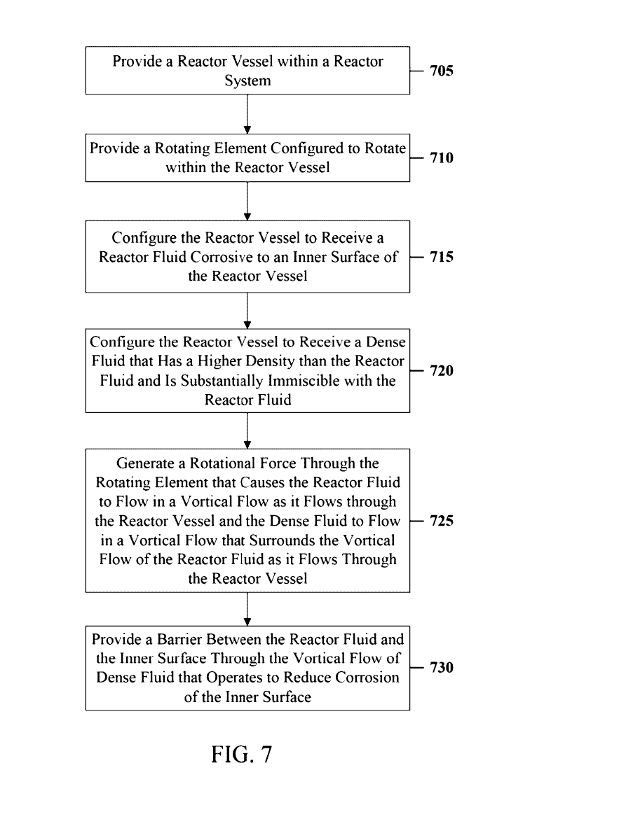

FIG. 7 depicts a flow diagram for an illustrative corrosion reduction method for a reactor system according to a first embodiment. A reactor vessel may be provided 705 within a reactor system. A rotating element may be provided 710 that is configured to rotate within the reactor vessel. In an embodiment, the rotating element may include an impeller. The reactor vessel may receive 715 a reactor fluid corrosive to an inner surface of the reactor vessel. For instance, the reactor fluid may include corrosive ions that may corrode the material forming the reactor vessel. The reactor vessel may also receive 720 a dense fluid that has a higher density and that is substantially immiscible with the reactor fluid.

A rotational force may be generated 725 through the rotating element that causes the reactor fluid to flow in a vortical flow as it flows through the reactor vessel and the dense fluid to flow in a vortical flow that surrounds the vortical flow of the reactor fluid as it flows through the reactor vessel. In an embodiment, the reactor fluid and the dense fluid may flow through the reactor vessel in opposite directions. The vortical flow of the dense fluid may provide 730 a barrier between the reactor fluid and the inner surface that operates to reduce corrosion of the inner surface.

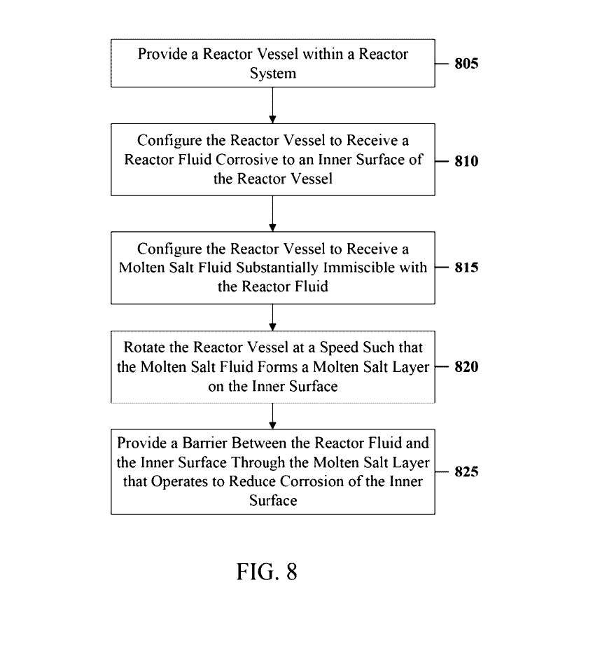

FIG. 8 depicts a flow diagram for an illustrative corrosion reduction method for a reactor system according to a second embodiment. A reactor vessel may be provided 805 within a reactor system. The reactor vessel may receive 810 a reactor fluid corrosive to an inner surface of the reactor vessel. The reactor vessel may also receive 815 a molten salt fluid that is substantially immiscible with the reactor fluid. In an embodiment, the molten salt fluid may have a higher density than the reactor fluid. The reactor vessel may be rotated 820 at a speed such that the molten salt forms a molten salt layer on the inner surface. The molten salt layer may provide 825 a barrier between the reactor fluid and the inner surface that reduces corrosion of the inner surface by limiting contact between the reactor fluid and the inner surface.

### EXAMPLES

### Example 1

### Supercritical Water Coal Gasification System with Dense Fluid Barrier

A supercritical water reactor system will be configured to generate a synthesis gas including H₂ and CH₄ from a coal slurry formed from pulverized coal and water. The coal slurry will be in the form of an aqueous slurry that will react with supercritical water in a reactor vessel of the supercritical water reactor system to generate the synthesis gas.

The coal slurry will be introduced into the system at a temperature below about 200° C. and will be heated in a pre-heater before entering a reactor vessel. The pre-heater will be formed from stainless steel and will have a substantially cylindrical shape, with a height of about 4 meters and a diameter of about 1.5 meters. Within the pre-heater, the temperature of the coal slurry will reach about 300° C. to about 350° C. within a highly corrosive zone in which corrosive ions within the coal slurry will solvate and cause the coal slurry to be highly corrosive to the inner surface of the pre-heater.

An impeller including a magnetically coupled drive shaft configured to rotate four brass blades will be positioned within the pre-heater, about 0.25 meters from the bottom of the pre-heater. A coal slurry input may be positioned below the impeller, about 0.15 meters from the bottom of the pre-heater, and a coal slurry output may be positioned at a top portion of the reactor vessel in fluid communication with the reactor vessel. A dense fluid inlet may be positioned just above a top portion of the highly corrosive zone to allow a dense fluid including molten nickel alloy to enter the pre-heater. The dense fluid will be substantially immiscible with the reactor fluid. A dense fluid outlet will be positioned below the impeller at about 0.2 meters from the bottom of the reactor vessel to allow the dense fluid to exit the pre-heater. The dense fluid will be recaptured and reused within the system as part of a continuous flow system providing a consistent flow of the dense fluid to the pre-heater.

The impeller will rotate at about 1200 revolutions per minute and will cause the dense fluid and the coal slurry to rotate in separate vortical flows. The dense fluid vortical flow will be located at an outermost portion of the pre-heater substantially contiguous with the inner surface of the pre-heater. The coal slurry vortical flow will be at an inner portion of the pre-heater relative to the vortical flow of the dense fluid. The dense fluid vortical flow will surround the coal slurry in the highly corrosive zone and will provide a barrier preventing the coal slurry from contacting the inner surface. Accordingly, the corrosive ions in the coal slurry will not react with or cause corrosion of the inner surface of the pre-heater, prolonging the life of these components within the supercritical water coal gasification system relative to a similar system lacking the dense fluid barrier.

### Example 2

### Supercritical Water Biomass Reactor System with Rotating Reactor Vessel

A supercritical water biomass gasification system will include a substantially horizontally orientated cylindrical reactor vessel having a length of about 5 meters and a diameter of about 2 meters. A pump will pump a biomass slurry at a subcritical temperature of about 350° C. at a pressure of about 23 megapascals from a pre-heater through a slurry inlet at a first end of the reactor vessel and out through a slurry outlet at a second end. The slurry outlet will be in fluid communication with a heat exchanger. The reactor vessel will be fabricated from Hastelloy® N and will include a coated with a ceramic refractory lining on an inner surface thereof. The reactor vessel will be arranged within a support vessel formed from a nickel alloy material. A layer of ceramic bearings will be arranged between the reactor vessel and the support vessel to support rotation of the reactor vessel. A protective fluid inlet will allow a molten salt fluid including lithium fluoride and beryllium fluoride (FLiBe) to enter the reactor vessel at the first end. The FLiBe molten salt will exit through a protective fluid outlet at a second end of the reactor vessel.

A gas-powered motor will be coupled to a shaft connected to the reactor vessel. Engagement of the motor will cause the reactor vessel to rotate at about 800 revolutions per minute to about 1000 revolutions per minute. The speed of rotation of the reactor vessel will impart a centripetal acceleration on the molten salt fluid greater than that of the acceleration of gravity such that the molten salt fluid rotates in a protective layer at an outermost part of the reactor vessel substantially contiguous with the inner surface thereof. The biomass slurry will flow through the reactor vessel within the molten salt fluid layer such that corrosive ions within the biomass slurry will be prevented from contacting the inner surface and/or the ceramic refractory lining.

The molten salt fluid layer will provide a physical barrier reducing or eliminating contact between the biomass slurry and the inner surface of the reactor vessel, thereby reducing corrosion of the reactor vessel during the supercritical water biomass gasification process relative to a similar system lacking the molten salt fluid layer.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to”). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example), the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, or the like. As a non-limiting example, each range discussed herein can be readily broken down into a lower third, a middle third, and an upper third. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1.-63. (canceled)

64. A method of reducing corrosion in a reactor system, the method comprising:
providing a reactor vessel comprising an inner surface;
receiving a reactor fluid at the reactor vessel corrosive to at least a portion of the inner surface;
receiving a molten salt fluid at the reactor vessel, the molten salt fluid being substantially immiscible with the reactor fluid; and
rotating the reactor vessel at a speed such that at least a portion of the molten salt fluid forms a molten salt layer on the at least a portion of the inner surface, the molten salt layer operating to reduce corrosion by forming a barrier between the reactor fluid and the at least a portion of the inner surface.

65. (canceled)

66. The method of claim 64, wherein providing the reactor vessel comprises providing a reactor vessel arranged in a substantially horizontal orientation and rotating the reactor vessel comprises rotating at a speed sufficient to generate a centripetal acceleration on at least a portion of the molten salt fluid greater than that of the acceleration of gravity on the at least a portion of the molten salt fluid entering the reactor vessel.

67. The method of claim 64, further comprising providing a support structure, wherein the reactor vessel is housed in the support structure.

68. The method of claim 67, further comprising providing a rotation support element disposed between the support structure and the reactor vessel to facilitate rotation of the reactor vessel within the support structure.

69. The method of claim 68, wherein providing the rotation support element comprises providing a rotation support fluid including the molten salt fluid.

70. (canceled)

71. The method of claim 68, wherein providing the rotation support element comprises providing ceramic bearings.

72. The method of claim 64, wherein receiving the molten salt fluid comprises receiving:
lithium fluoride and beryllium fluoride;
lithium fluoride, sodium fluoride and potassium fluoride;
sodium nitrate, sodium nitrite and potassium nitrate;
potassium chloride and magnesium chloride;
rubidium chloride and zirconium fluoride; or
any combination thereof.

73. The method of claim 64, wherein rotating comprises rotating at about 1 revolution per minute to about 1000 revolutions per minute.

74. (canceled)

75. A method of manufacturing a reactor system, the method comprising:
providing a reactor vessel comprising an inner surface;
configuring the reactor vessel to receive a reactor fluid corrosive to at least a portion of the inner surface and a molten salt fluid, the reactor fluid and the molten salt fluid being substantially immiscible;
connecting at least one reactor vessel rotator to the reactor vessel, the at least one reactor vessel rotator configured to rotate the reactor vessel at a speed such that at least a portion of the molten salt fluid forms a molten salt layer on the at least a portion of the inner surface, the molten salt layer operating to reduce corrosion by forming a barrier between the reactor fluid and the at least a portion of the inner surface.

76. (canceled)

77. The method of claim 75, further comprising arranging the reactor vessel in a substantially horizontal orientation and connecting the at least one reactor vessel rotator comprises configuring the at least one reactor vessel rotator to rotate the reactor vessel at a speed sufficient to generate a centripetal acceleration on at least a portion of the molten salt fluid greater than that of the acceleration of gravity on the at least a portion of the molten salt fluid entering the reactor vessel.

78.-82. (canceled)

83. The method of claim 75, further comprising providing a support structure, wherein the reactor vessel is housed in the support structure.

84. The method of claim 83, further comprising:
providing a rotation support element disposed between the support structure and the reactor vessel; and
configuring the rotation support element to facilitate rotation of the reactor vessel in the support structure.

85. The method of claim 84, wherein providing the rotation support element comprises providing a rotation support fluid including the molten salt fluid.

86. (canceled)

87. The method of claim 84, wherein providing the rotation support element comprises providing ceramic bearings.

88.-99. (canceled)

100. A reactor system configured to reduce corrosion of portions thereof, the system comprising:
a reactor vessel comprising an inner surface and configured to receive a reactor fluid corrosive to at least a portion of the inner surface and a protective fluid substantially immiscible with the reactor fluid; and
a rotating element configured to generate a rotational force that forces at least a portion of the protective fluid to flow in a layer between the reactor fluid and the at least a portion of the inner surface, the layer operating to reduce corrosion by forming a barrier between the reactor fluid and the at least a portion of the inner surface.

101. The reactor system of claim 100, wherein the reactor system is configured as a supercritical water reactor system.

102. The reactor system of claim 100, wherein the reactor system is configured as one of a coal gasification system, a biomass gasification system and a waste oxidation system.

103. The reactor system of claim 100, wherein the reactor system is configured as a coal gasification system, and the reactor fluid comprises coal slurry.

104. The reactor system of claim 100, wherein the reactor system is configured as a biomass gasification system, and the reactor fluid comprises biomass slurry.

105. The reactor system of claim 100, wherein the reactor vessel is configured as one of a heater and a heat exchanger.

106. The reactor system of claim 100, wherein one or more of the reactor fluid and the protective fluid is disposed within at least a portion of the reactor vessel.

107. (canceled)

108. The reactor system of claim 100, wherein the at least a portion of the inner surface is located in a region of the reactor vessel configured to receive the reactor fluid at a temperature of about 300 degrees Celsius to about 350 degrees Celsius.

109. The reactor system of claim 100, wherein the rotating element comprises an impeller.

110. The reactor system of claim 100, wherein the protective fluid comprises a metal, a metal alloy, a molten salt, a hydrocarbon liquid, or a combination thereof.

111. The reactor system of claim 100, wherein the protective fluid comprises at least one of tin, zinc, aluminum, lead, bismuth, gallium, cadmium, an alloy of any of the foregoing, and combinations thereof.

112. (canceled)

113. The reactor system of claim 100, wherein the protective fluid comprises a molten salt fluid.

114. The reactor system of claim 100, wherein the protective fluid includes a molten salt fluid selected from the group consisting of:
lithium fluoride and beryllium fluoride;
lithium fluoride, sodium fluoride and potassium fluoride;
sodium nitrate, sodium nitrite and potassium nitrate;
potassium chloride and magnesium chloride; and
rubidium chloride and zirconium fluoride.

115. (canceled)

116. The reactor system of claim 100, wherein the reactor vessel is arranged in a substantially horizontal orientation and the speed is sufficient to generate a centripetal acceleration on the at least a portion of the protective fluid greater than that of the acceleration of gravity on the at least a portion of the protective fluid entering the reactor vessel.

117. The reactor system of claim 100, wherein the reactor vessel is housed in a support structure.

118. The reactor system of claim 117, further comprising a rotation support element disposed between the support structure and the reactor vessel, the rotation support element being configured to facilitate rotation of the reactor vessel within the support structure.

119. The reactor system of claim 118, wherein the rotation support element comprises a rotation support fluid.

120. (canceled)

121. The reactor system of claim 119, wherein the rotation support element comprises ceramic bearings.

122. The reactor system of claim 117, wherein the support structure comprises a nickel alloy.

123. The reactor system of claim 100, wherein the rotating element comprises a reactor vessel rotator configured at about 1 revolution per minute to about 1000 revolutions per minute.
